(19) United States
(12) Patent Application Publication
(10) Pub. No.: US 2019/0215562 A1
(43) Pub. Date: Jul. 11, 2019

(54) USING WIFI-SIGNAL BASED, DEVICE-FREE HUMAN PRESENCE DETECTION TECHNOLOGY TO IDENTIFY HUMANS CONSUMING MEDIA CONTENT

(71) Applicant: Axwave, Inc., Menlo Park, CA (US)

(72) Inventors: Damian Arial SCAVO, Redwood City, CA (US); Loris D'ACUNTO, Palo Alto, CA (US); Fernando FLORES REDONDO, Brooklyn, CA (US)

(21) Appl. No.: 16/032,986

(22) Filed: Jul. 11, 2018

Related U.S. Application Data
(60) Provisional application No. 62/531,275, filed on Jul. 11, 2017.

(51) Int. Cl. H04N 21/442; G01V 3/12

(52) U.S. Cl. CPC H04N 21/44218; G01V 3/12

(57) ABSTRACT

A computer-implemented method includes detecting a presence of a subject in a vicinity of radio transceivers based on radio signal strength variations received at an input of the radio transceivers as a radio signature, so as to recognize the presence of the subject in an indoor environment by analyzing and quantifying irregularities in the radio signature, wherein the detecting the presence does not incorporate sensors for subject detection, and only performs the detecting based on radio irregularity phenomenon, without modifying the indoor environment; and mixing the detected presence of the subject with viewership datasets derived from an audience measurement source, to generate rich result datasets that provide insights on media exposure at a personal and household level, and to assign personal viewership insights to the household audience observation, without sacrificing personal privacy of the subject, and without requiring additional hardware or detection signals.

This application claims priority under 35 USC 119(a) to U.S. Provisional Application No. 62/531,275, filed on Jul. 11, 2017, the content of which is incorporated herein by reference in its entirety for all purposes.

### BACKGROUND

### 1. Related Art

Related art approaches have employed cameras or other detectors to perform facial recognition techniques, to directly obtain the personal information of the user, and to use this information about the appearance of the user to determine the identity of the user. However, such approaches are intrusive as noted above, and may be unacceptable to users from a privacy perspective. Further, related art approaches may combine such appearance information associated with the user with other data. However, such approaches are not predictive, but are actually determinative because the identity of the user is actually known and not hidden. Thus, the demographic of the user can be deterministically obtained by first knowing the identity of the user, and then simply gathering or researching the associated demographics of the user, possibly further sacrificing the privacy of the user.

To avoid such intrusive approaches, there is a need to employ a method that does not obtain, receive or collect the appearance information of the user, is limited to the most basic information necessary to determine the existence of a user, which are size and movement. To date, there are no known related art approaches that employ this technique, such that only the most basic information is collected, and no other appearance information of the user is collected, while being able to obtain demographic information associated with the user.

### SUMMARY

The objective of the example implementations is to describe a process that, using Wi-Fi signal transceivers present in any media device (i.e. Router, Smart TV, Wi-Fi connected speaker, mobile phone) is able to identify and categorize humans consuming media within the range of the Wi-Fi signal in order to enhance personal viewership insights. For example, a process is provided in the present example implementation that uses device-free human presence detection techniques to identify who in the household is watching TV.

It is another object of the example implementations to be able to precisely and accurately predict demographics associated with a user of a media device, without using any intrusive means that may sacrifice privacy, such as a camera or other recording or information storing device that may detect and will restore personal identification information of the user.

According to an example implementation, a computer-implemented method may include detecting a presence of a subject in a vicinity of one or more radio transceivers based on one or more radio signal strength variations received at an input of the one or more radio transceivers as a radio signature, so as to recognize the presence of the subject in an indoor environment by analyzing and quantifying irregularities in the radio signature, wherein the subject is categorized into one of an adult, a child, or a pet; wherein the detecting the presence does not incorporate one or more sensors for subject detection, and only performs the detecting based on radio irregularity phenomenon, without modifying the indoor environment, and further wherein the one or more radio transceivers comprises a Wi-Fi signal transceiver that can be part of a Wi-Fi powered device in the indoor environment; and mixing the detected presence of the subject with viewership datasets derived from an audience measurement source, to generate rich result datasets that provide insights on media exposure at a personal and household level, and to assign personal viewership insights to the household audience observation, without sacrificing personal privacy of the subject, and without requiring additional hardware or detection signals.

### BRIEF DESCRIPTION OF THE DRAWINGS

FIG. 1 illustrates an example implementation.

FIG. 2 illustrates a schematic of the generation of the viewership information.

FIG. 3 illustrates an example process.

FIG. 4 illustrates an example environment.

FIG. 5 illustrates an example processor.

### DETAILED DESCRIPTION

### Technical Description

The presence of a human in the vicinity of radio transceivers results in radio signal strength variations at the receiver's input. Therefore, human presence in an indoor environment can be recognized by analyzing and quantifying irregularities in the radio signature. Based on such irregularities, basic categorization of the subject can be done: adult, children or even pet, case in which the presence would be discarded.

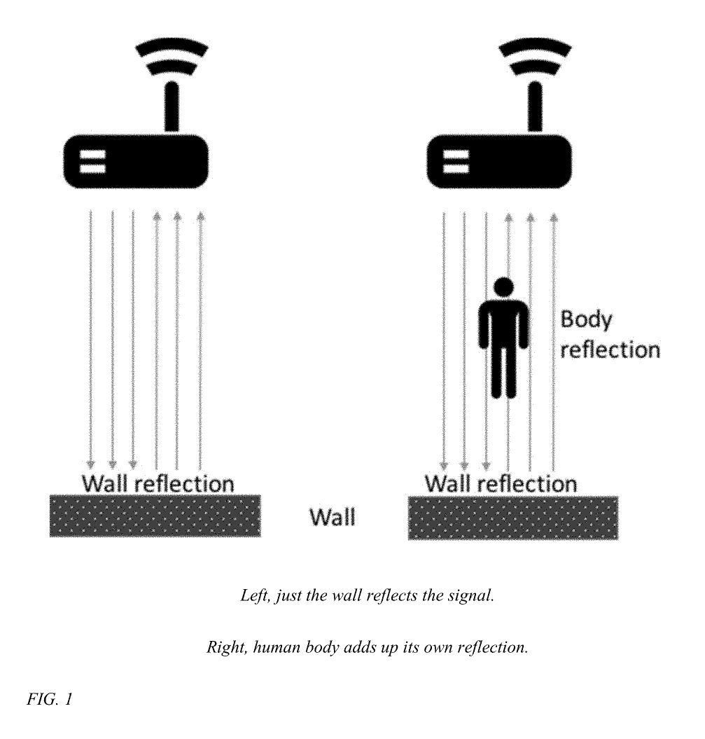

In order to quantify the information in terms of human presence, methods based on information entropy extracted from a sequence of received signal strength samples or on human motion induced signal attenuation reflected by the physical layer channel state information (CSI) can be used. Such methods exploit the fact that human bodies interfere with radio signals, causing fading and shadowing effects. Therefore, irregularities in the radio signature, given in a form of received signal strength indicator's (RSSI) variations, are considered as an indication of possible human presence in the room. This example aspect is shown in FIG. 1.

### Hardware Requirements

As opposed to existing smart home solutions that incorporate a complex set of sensors for human detection, the proposed method is solely based on radio irregularity phenomenon, without modifying the original environment. The only hardware requirement is a Wi-Fi signal transceiver, that can be part of any Wi-Fi powered device in the house, ideally the Smart TV for which viewership is studied.

Accordingly, there is no need for any other dedicated peripheral or other device, such as camera or sensors or detectors. Further, because the Wi-Fi signals are already being transmitted, there is no need for a separate signal to even be generated; the Wi-Fi signals are simply further processed in order to identify object size, and object movement. From this information, further inference and prediction is performed and mixed by software, as explained below.

### Software Basic Functionality

The device hosting the Wi-Fi transceiver will run software to log all relevant changes in the environment:
Adult in/out
Child in/out
   As well as periodic snapshots of the situation:
11:00:00—1 adult and 2 children
11:05:00—2 adults and 2 children

The above examples are exemplary, and are not intended to be limiting. Further size and movement information may be used to perform additional analytic or predictive activities, as would be understood by those skilled in the art. However, in all of the example implementations, the appearance information of the user is not collected or stored, and no additional hardware or dedicated signals are used to obtain the snapshots.

### Results Generation

The main objective is generating rich result datasets that provide insights on media exposure at a personal and household level. Human presence results are to be combined with viewership datasets coming from any audience measurement source (i.e. automatic content recognition solution, poll based panel) in order to assign personal viewership insights to the household audience observation.

A third layer of accuracy includes adding previously known household demographics information (i.e. household member's age, gender, zip code, etc.) in order to generate richer results.

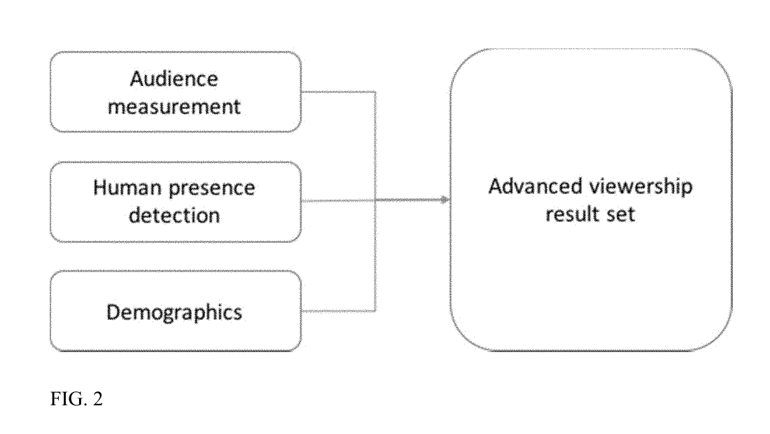

Accordingly, the human presence detection is mixed with demographic information based on the location of the user (optionally, the user may choose to share other demographic information than location), and third party audience information, to generate more precise and accurate viewership information without sacrificing personal privacy of the user, and without requiring additional hardware or detection signals. A schematic of the generation of the viewership information is shown in FIG. 2.

Aspects of the example implementations are directed to detecting only size and movement of a user, and not detecting any further private or identification information of the user. The example implementations do not create an image or three-dimensional shape associated with the user. Further, the example implementations including the foregoing aspects operate in short-range communication, having substantially the same range as Wi-Fi communications, as opposed to long-range or microwave communication signals.

One possible benefit of the example implementations is that the information which is provided as an output of the system can be obtained in a simple manner, and with greater speed than the foregoing related art. Further, another possible benefit of the example implementations is that the privacy of the user is protected by only detecting size and movement, and not detecting any further personal identification information.

By taking advantage of the existing Wi-Fi signal, the example implementations need not generate a separate dedicated signal to detect the presence or identity of the users. Thus, the example implementations are substantially more simple and require substantially less processing power than related art approaches that attempt to use a camera or other sensing means, information associated with the device of the user in combination therewith, to obtain the desired information.

Further, and as explained herein, the output of the example implementations, which indicates size and movement of the user, is mixed with software, such as a series of instructions contained in a non-transitory computer readable medium. The instructions receive the output and mix the output with other data, to determine the demographics associated with the obtained output. By performing this mixing, increased accuracy of the user demographic can be obtained. Further, by including location information, regional predictive tools can be used, such that an output obtained in the United States or Europe can be treated differently, based on different user behavior patterns in the different regions. While regions are one example of the way in which data can be mixed with the size and movement output, other types of data may be substituted therefore without departing from the inventive scope, as would be understood by those skilled in the art.

As explained above, the new datasets complement the existing ones by adding the “WHO is in from of the TV” variable on top of ACR insights on ‘WHAT is being watched’.

According to an example implementation of a use case, the following may occur with the present example implementations associated with the inventive concept:
An ACR powered Smart TV is used to capture media exposure.
In the morning, the ACR identifies that media (e.g., “Good Morning America”) is being watched.
The human presence detector according to the example implementations, installed in the smart TV as well, detects one adult.
So, both datasets (‘Good Morning America is being watched’ plus ‘one adult is in front of the TV’) are combined and generate a more complete insight on the media exposure.

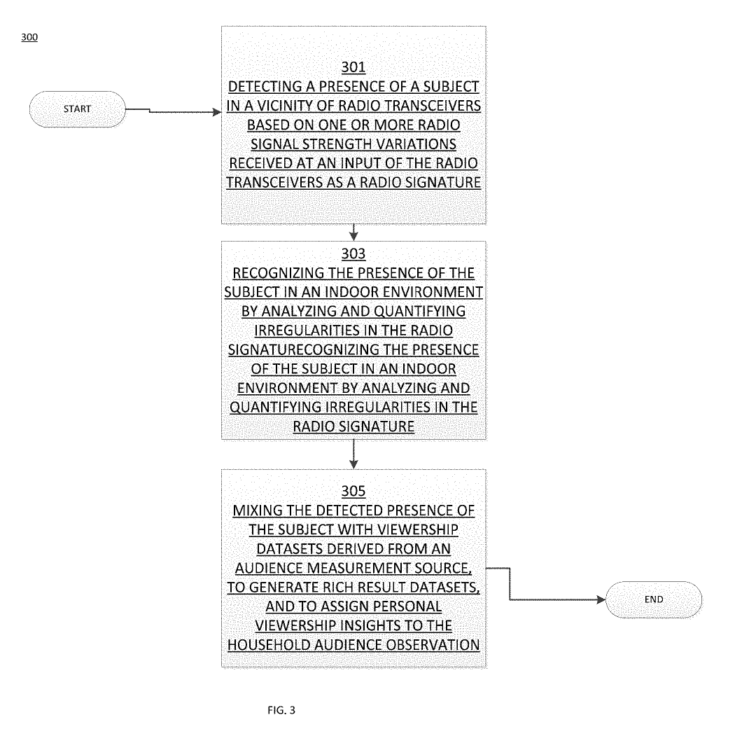

FIG. 3 illustrates an example process, such as a computer-implemented method, according to the example implementations. Operations of the method may be performed at the client side, server-side, or a combination thereof.

More specifically, at a first operation 301, detecting a presence of a subject in a vicinity of one or more radio transceivers based on one or more radio signal strength variations received at an input of the one or more radio transceivers as a radio signature, is disclosed.

At operation 303, an operation is disclosed as recognizing the presence of the subject in an indoor environment by analyzing and quantifying irregularities in the radio signature, wherein the subject is categorized into one of an adult, a child, or a pet. For example the detecting the presence does not incorporate one or more sensors for subject detection, and only performs the detecting based on radio irregularity phenomenon, without modifying the indoor environment, and further the one or more radio transceivers comprises a Wi-Fi signal transceiver that can be part of a Wi-Fi powered device in the indoor environment; and

At 303, an operation is directed to mixing the detected presence of the subject with viewership datasets derived from an audience measurement source, to generate rich result datasets that provide insights on media exposure at a personal and household level, and to assign personal viewership insights to the household audience observation, without sacrificing personal privacy of the subject, and without requiring additional hardware or detection signals.

### Example Computing Devices and Environments

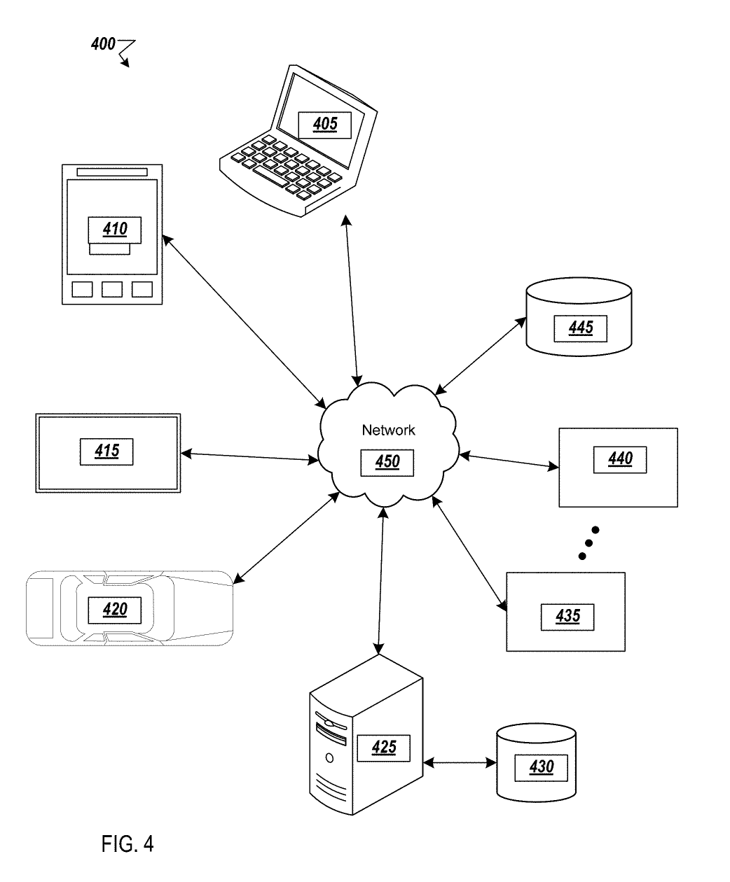

FIG. 4 shows an example environment suitable for some example implementations. Environment 400 includes devices 405-445, and each is communicatively connected to at least one other device via, for example, network 460 (e.g., by wired and/or wireless connections). Some devices may be communicatively connected to one or more storage devices 430 and 445.

An example of one or more devices 405-445 may be computing devices 605 described in FIG. 6, respectively. Devices 405-445 may include, but are not limited to, a computer 405 (e.g., a laptop computing device) having a monitor and an associated webcam as explained above, a mobile device 410 (e.g., smartphone or tablet), a television 415, a device associated with a vehicle 420, a server computer 425, computing devices 435-440, storage devices 430 and 445. The devices may be communicatively connected, including but not limited to AR peripherals that are well known in the art to permit a user to interact in AR, VR, mixed reality, or other environments. Further, the devices may include media object capture hardware, as would be understood by those skilled in the art.

In some implementations, devices 405-420 may be considered user devices associated with the users of the enterprise. Devices 425-445 may be devices associated with service providers (e.g., used by the external host to provide services as described above and with respect to the various drawings, and/or store data, such as webpages, text, text portions, images, image portions, audios, audio segments, videos, video segments, and/or information thereabout).

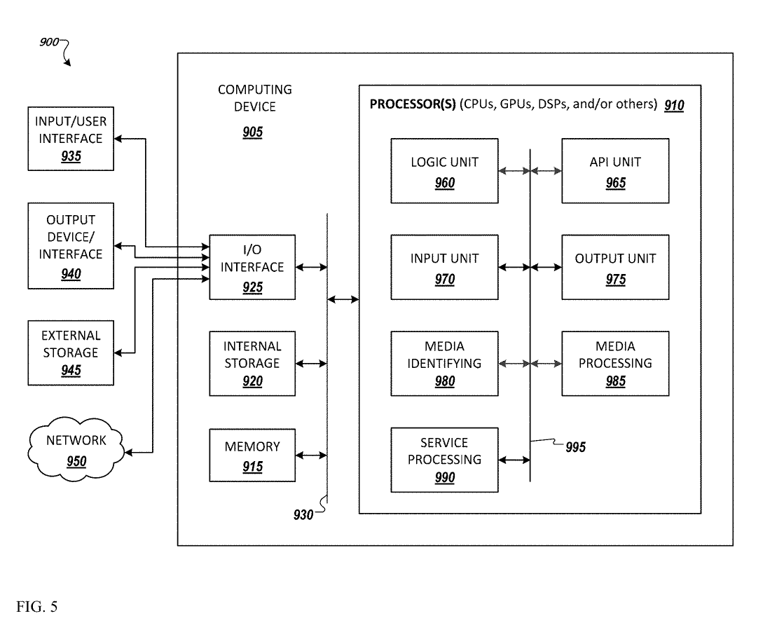

FIG. 5 shows an example computing environment with an example computing device suitable for implementing at least one example embodiment. Computing device 905 in computing environment 900 can include one or more processing units, cores, or processors 910, memory 915 (e.g., RAM, ROM, and/or the like), internal storage 920 (e.g., magnetic, optical, solid state storage, and/or organic), and I/O interface 925, all of which can be coupled on a communication mechanism or bus 930 for communicating information. Processors 910 can be general purpose processors (CPUs) and/or special purpose processors (e.g., digital signal processors (DSPs), graphics processing units (GPUs), and others).

In some example embodiments, computing environment 900 may include one or more devices used as analog-to-digital converters, digital-to-analog converters, and/or radio frequency handlers.

Computing device 905 can be communicatively coupled to input/user interface 935 and output device/interface 940. Either one or both of input/user interface 935 and output device/interface 940 can be wired or wireless interface and can be detachable. Input/user interface 935 may include any device, component, sensor, or interface, physical or virtual, which can be used to provide input (e.g., keyboard, a pointing/cursor control, microphone, camera, Braille, motion sensor, optical reader, and/or the like). Output device/interface 940 may include a display, monitor, printer, speaker, braille, or the like. In some example embodiments, input/user interface 935 and output device/interface 940 can be embedded with or physically coupled to computing device 905 (e.g., a mobile computing device with buttons or touch-screen input/user interface and an output or printing display, or a television).

Computing device 905 can be communicatively coupled to external storage 945 and network 950 for communicating with any number of networked components, devices, and systems, including one or more computing devices of the same or different configuration. Computing device 905 or any connected computing device can be functioning as, providing services of, or referred to as a server, client, thin server, general machine, special-purpose machine, or another label.

I/O interface 925 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, satellite network, and the like).

Computing device 905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 905 can be used to implement techniques, methods, applications, processes, or computer-executable instructions to implement at least one embodiment (e.g., a described embodiment). Computer-executable instructions can be retrieved from transitory media, and stored on and retrieved from non-transitory media. The executable instructions can be originated from one or more of any programming, scripting, and machine languages (e.g., C, C++, C#, Java, Visual Basic, Python, Perl, JavaScript, and others).

Processor(s) 910 can execute under any operating system (OS) (not shown), in a native or virtual environment. To implement a described embodiment, one or more applications can be deployed that include logic unit 960, application programming interface (API) unit 965, input unit 970, output unit 975, media identifying unit 980, media processing unit 985, service processing unit 990, and inter-unit communication mechanism 995 for the different units to communicate with each other, with the OS, and with other applications (not shown). For example, media identifying unit 980, media processing unit 985, and service processing unit 990 may implement one or more processes described above. The described units and elements can be varied in design, function, configuration, or implementation and are not limited to the descriptions provided.

In some example embodiments, when information or an execution instruction is received by API unit 945, it may be communicated to one or more other units (e.g., logic unit 960, input unit 970, output unit 975, media identifying unit 980, media processing unit 985, service processing unit 990). For example, after input unit 970 has received or detected a media file (e.g., Segment S), input unit 970 may use API unit 965 to communicate the media file to media processing unit 985. Media processing unit 985 communicates with media identifying unit 980 (e.g., Wi-Fi as explained above) to detect the presence of the human. Media processing unit 985 goes through, for example, the above-explained process to process and generate the recognition of the presence, such as the category of the subject without sacrificing personal privacy. Service processing unit 990 performs the mixing and generation of the results, as also explained above.

In some examples, logic unit 960 may be configured to control the information flow among the units and direct the services provided by API unit 965, input unit 970, output unit 975, media identifying unit 980, media processing unit 985, service processing unit 990 in order to implement an embodiment described above. For example, the flow of one or more processes or implementations may be controlled by logic unit 960 alone or in conjunction with API unit 965.

Although a few example embodiments have been shown and described, these example embodiments are provided to convey the subject matter described herein to people who are familiar with this field. It should be understood that the subject matter described herein may be embodied in various forms without being limited to the described example embodiments. The subject matter described herein can be practiced without those specifically defined or described matters or with other or different elements or matters not described. It will be appreciated by those familiar with this field that changes may be made in these example embodiments without departing from the subject matter described herein as defined in the appended claims and their equivalents.

I/We claim:

1. A computer-implemented method, comprising:
detecting a presence of a subject in a vicinity of one or more radio transceivers based on one or more radio signal strength variations received at an input of the one or more radio transceivers as a radio signature, so as to recognize the presence of the subject in an indoor environment by analyzing and quantifying irregularities in the radio signature, wherein the subject is categorized into one of an adult, a child, or a pet;
wherein the detecting the presence does not incorporate one or more sensors for subject detection, and only performs the detecting based on radio irregularity phenomenon, without modifying the indoor environment, and further wherein the one or more radio transceivers comprises a Wi-Fi signal transceiver that can be part of a Wi-Fi powered device in the indoor environment; and
mixing the detected presence of the subject with viewership datasets derived from an audience measurement source, to generate rich result datasets that provide insights on media exposure at a personal and household level, and to assign personal viewership insights to the household audience observation, without sacrificing personal privacy of the subject, and without requiring additional hardware or detection signals.
